(19) United States
(12) Patent Application Publication
(10) Pub. No.: US 2014/0278620 A1
(43) Pub. Date: Sep. 18, 2014

(54) METHOD AND SYSTEM FOR DETERMINING MARKETING ATTRIBUTIONS

(71) Applicant: ORACLE INTERNATIONAL CORPORATION, Redwood Shores, CA (US)

(72) Inventors: Arif Rashid Khan, Aurora, IL (US); Justin Thomas Anderson, Sunnyvale, CA (US); Sundeep Parsa, San Jose, CA (US)

(73) Assignee: ORACLE INTERNATIONAL CORPORATION, Redwood Shores, CA (US)

(21) Appl. No.: 13/802,804

(22) Filed: Mar. 14, 2013

(51) Int. Cl. G06Q 30/02; G06Q 10/06

(52) U.S. Cl. CPC G06Q 30/0201; G06Q 30/0242; G06Q 10/0631; G06Q 30/0243
USPC 705/7.12; 705/14.41; 705/14.42

(57) ABSTRACT

Disclosed is an improved approach for performing opportunity association and attribution analysis. An advanced rules framework is provided to automatically infer associations between a set of marketing data and a set of sales data, allowing advanced revenue funnel analytics to be performed to measure marketing campaigns.

### BACKGROUND

The present application relates to systems, methods, and computer program products for implementing enterprise software applications.

Many types of business logic are implemented by enterprise software applications. For example, many enterprise applications are focused on business logic to perform marketing, sales, and/or customer relations management (CRM) tasks. Examples of such business logic include tools that facilitate marketing campaigns, sales processes and order capture, and customer management.

There are at least two main groups within a typical enterprise that use these tools. The first group is the marketing department, which develops and implements marketing campaigns. The goal of these campaigns to generate leads for the enterprise. The leads are then passed to the second group within the enterprise, which is the sales department. The sales department converts the leads to opportunities which hopefully turn into captured sales/orders for the enterprise.

It is desirable to have unified revenue funnel analytics that can measure the effectiveness and productivity of the marketing department, and can therefore tie specific marketing campaigns to revenue derived from the opportunities associated with the campaigns. The problem is that conventional systems do not provide very effective mechanisms to perform this type of analysis.

One known approach is to require enterprises to make specific entries into the CRM system that explicitly relate an opportunity to a marketing sourced lead. These manually entered entries into the system allow for revenue analytics for the marketing activities. However, this approach suffers from some fundamental flaws. For example, the validity of this approach assumes that diligent data entry is going to be made that accurately and correctly relates the marketing activity to its corresponding lead. Failure to maintain the proper diligence, comprehensiveness, or accuracy for the data entry will create unreliable analysis results. Moreover, this approach relies upon human assumptions about the source of revenue from marketing activities, and may therefore suffer from any faulty assumptions made for the entries.

Another possible approach is to create custom processes to connect the marketing data with the sales data in the enterprise software system. The problem with this approach is that it typically requires a high level of customized configuration and programming for the software system, which makes this approach difficult to be adopted by many users that need to use the enterprise application. This is especially true if those users do not have the experience and capability to create highly customized enterprise software.

Yet another approach is to provide rules for correlating marketing data to sales data. However, existing and known enterprise applications either do not have these types of mechanisms, or only have rudimentary rules abilities to perform analysis of the marketing data. They do not provide an advanced rules framework that permits the enterprise application to make accurate and flexible analysis of the marketing data relative to the sales data.

Therefore, there is a need for an improved approach to implement enterprise software systems that address these and other problems.

### SUMMARY

According to some embodiments of the invention, disclosed is a system, method, and program product for performing opportunity association and attribution analysis. The invention provides an advanced rules framework to automatically infer associations between a set of marketing data and a set of sales data, allowing advanced revenue funnel analytics to be performed to measure marketing campaigns.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 illustrates a system for performing opportunity association and attribution analysis.

FIG. 2 shows a flowchart of a process for performing opportunity association and attribution analysis.

FIG. 3 illustrates an example set of association rules.

FIG. 4 logically illustrates opportunity associations.

FIG. 5 shows a flowchart of a process for performing opportunity associations.

FIG. 6 illustrates that a given opportunity can be associated to different marketing activities based on association rule definitions.

FIG. 7 shows a flowchart of a process for performing attribution analysis.

FIG. 8 illustrates an example approach for performing model selection.

FIG. 9 illustrates an example approach to select association rules to be used within a model.

FIG. 10 illustrates an example approach to add an additional association rule from a library.

FIG. 11 illustrates an example approach to perform finalization.

FIG. 12 shows an example approach to configure the association rule.

FIG. 13 illustrates an example interface that can be employed to select program priorities.

FIG. 14 illustrates an example interface that can be employed to configure revenue attribution parameters.

FIG. 15 illustrates an example approach to configure the association rule.

FIG. 16 illustrates an example interface that can be employed to select program priorities.

FIG. 17 illustrates an example interface that can be employed to configure revenue attribution parameters.

FIG. 18 illustrates an example interface that can be employed to add additional activity-program type combinations and assign weights to these categories.

FIG. 19 is a diagram of an illustrative system that can be used in some embodiments of the invention.

FIG. 20 illustrates logical interactions between the data in the system to generate the opportunity association links and the revenue attribution analysis results.

FIG. 21 is a block diagram of an illustrative computing system 1400 suitable for implementing an embodiment of the present invention.

### DETAILED DESCRIPTION

According to some embodiments of the invention, disclosed is a system, method, and program product for performing opportunity association and attribution analysis. The invention provides an advanced rules framework to automatically infer associations between a set of marketing data and a set of sales data, allowing advanced revenue funnel analytics to be performed to measure marketing campaigns.

FIG. 1 illustrates an example system which may be employed in some embodiments of the invention. The system includes one or more users at one or more user stations 102 that operate the system. The user station 102 comprises any type of computing station that may be used to operate or interface with the system. Examples of such user stations 102 include, for example, workstations, personal computers, or remote computing terminals. The user station 102 comprises a display device, such as a display monitor, for displaying a user interface to users. The user station 102 also comprises one or more input devices for the user to provide operational control over the activities of the system, such as a mouse or keyboard to manipulate a pointing object in a graphical user interface to generate user inputs to the marketing attribution tool 110 or the enterprise application 108.

The attribution and association tool 110 provides a framework for automatically inferring associations between marketing data and sales data. One or more models are provided to measure the impact of the marketing activities on the sales pipeline. Configurable association rules are used by the attributing/association tool 110 to correlate the marketing activities to the results of the sales activities. Various models may be employed to attribute sales revenue to marketing activities.

The attribution/association tool 110 is utilized in conjunction with an enterprise application 108. Any enterprise application that is used in the context of marketing and/or sales activities, and which generate data corresponding to those activities, may be used in conjunction with the present invention. For example, many types of business logic for marketing/sales activities are implemented by CRM applications, e.g., to track marketing opportunities, perform price quotations, and/or generate order capture for customers. Therefore, in some embodiments, the attribution/association tool 110 may be integrated into or otherwise associated with the enterprise application 108. Alternatively, the attribution/association tool 110 merely accesses the data 112 maintained by the enterprise application.

As mentioned above, a set of association rules may be used to correlate the marketing programs to eventual sales and/or revenues from the sales. Rather than merely providing a set of simplistic rules for the analysis, the present invention presents a framework that allows any number of analysis models to be utilized. Each analysis model is configurable to define a specific purpose for the analysis being conducted. Configurable rules of any suitable complexity may be employed to implement the analysis models. The configurable rules can be used to identify data situations (or “links”) 114 which match opportunity attribution conditions for their related models. Models can be configured to flexibly attribute revenue from the sales activities to one or more of the marketing data sets, which generate revenue attribution data 115.

The data within the system (e.g., CRM data 112, opportunity association data, and/or revenue attribution data 115) can be stored into a database 116 in a computer readable storage device. The computer readable storage device comprises any combination of hardware and software that allows for ready access to the data that is located at the computer readable storage device. For example, the computer readable storage device could be implemented as computer memory operatively managed by an operating system. The computer readable storage device could also be implemented as an electronic database system having storage on persistent and/or non-persistent storage.

For the purposes of illustration and explanation, the present disclosure is described in various embodiments in the context of CRM applications. It is noted, however, that the invention is not limited in its scope to CRM applications, and indeed, may be applied to other types of applications as well.

FIG. 2 shows a flowchart of a process for performing marketing attribution and associations according to some embodiments of the invention. At 202, the marketing data set and the sales data sets are identified and/or received for processing. The set of marketing data pertains to one or more marketing programs, along with details about those programs. The set of sales data pertains to information about accounts and sales made to those accounts. Examples of data within these data sets include information about offers, contacts, marketing activities, leads, contacts, and/or opportunities.

At 204, association links are generated. The links provide a set of data that correspond to associations that are identified between the marketing data set and the sales data set. These links are based upon matching conditions that apply to data within the data sets. A set of rules are used by a rule engine to generate the links.

At 206, attribution analysis is then performed using the opportunity association data. There are any number of attribution models that can be used to perform the attribution analysis, where a model can be created to address a particular purpose for which the analysis being conducted. For example, one example model might be used with the purpose of identifying the first program that sources a given opportunity. Another example model can be used for the purpose of finding the program that tipped a lead into a face-to-face meeting.

One example type of model is the “sourcing model”, which identifies a unique program that is the “source” for a positive impact on the pipeline. Another type of model is the “tipping point” model. The tipping point model identifies a set of programs that help pipeline move from one stage to another. This analysis helps companies identify trends that can match campaign tactics with pipeline stages. A third example type of model is the “influence” model (also referred to as the “influencing” model). An influence model tries to quantify the impact of various tactics on the overall pipeline. Typically, the influence analysis covers a broader set of stages in the pipeline.

It is noted that in this embodiment, the influencing model is the most general of the three models (sourcing, tipping point, and influence). In some embodiments, the sourcing model and/or the tipping point models comprise logic that can be constructed using the influencing model.

The selected model(s) are used to perform the attribution analysis, where the analysis results provide data that attribute some or all of the revenue from the sales data to some or all of the marketing programs. At 208, the analysis results are stored into a computer readable storage medium and/or are displayed to the user on a display device.

FIG. 3 shows an example set of association rules 302 that can be used in some embodiments of the invention. In some embodiments, a library of standard association rules are provided, which are modifiable to vary certain of the conditional parameters. For example, rule 304 is used to identify links in the marketing and sales between opportunities and emails that may correspond to those opportunities. Rule 304 is configurable as to the action taken for the email (e.g., whether the email is opened), a timeframe for the action on the email (e.g., “90 days”), and the event that takes place relative to the action on the email (e.g., an opportunity creation event). Entirely custom rules 306 may also be included as part of the set of association rules.

By applying the rules to the set of marketing and sales data, links can be identified between the marketing/sales data. For example, entry 308 shows the number of links that has been identified for the application of rule 304 to the analyzed data. FIG. 4 conceptually shows how opportunity association analysis can be used to cross-associate a set of data for a marketing program 402 to a set of data for a sales account 404 to generate opportunity associations 406.

FIG. 5 shows a flowchart of a process for generating association links according to some embodiments of the invention. The association process operates by connecting an opportunity to one or more marketing programs that qualify under specified conditions. The program activities are used to help establish the association. In addition, activities are checked within a time period to establish the association.

At 502, monitoring is performed to check for one or more events for an opportunity, where the link generation process is started based upon the appropriate triggering event. This action detects for certain events in the system. Such events are detected, for example, by checking when opportunities are created or edited, checking when contacts or leads are added to an account or opportunity, and/or checking when new marketing activities are recorded for contacts or leads attached to accounts or opportunities.

In some embodiments, the opportunities are evaluated by checking at least one of the following: (a) checking opportunities when they are created; (b) checking opportunities when they are updated; (c) checking opportunities when contacts are added/removed to/from an opportunity in the CRM system; (d) checking opportunities when contacts are added/removed to/from an account in the CRM system; (e) checking opportunities when new activities are recorded for contacts attached to an opportunity; and/or (f) checking opportunities when new activities are recorded for contacts attached to an account.

At 504, the specified conditions are checked to determine the opportunities to process. This action checks for conditions that determine which subset of opportunities meet a given criteria to act upon. The list of opportunities are filtered based on which opportunities meet criteria or transitioned to a certain state and/or which accounts, leads, or contacts meet criteria.

In some embodiments, the conditions that are checked may include one or more of the following: (a) value of a specific opportunity field corresponds to a certain value or range of values; (b) the opportunity meets a certain criteria; (c) opportunity belong to an account that meets a certain criteria; and/or (d) contact/lead attached to an account meets a certain criteria.

The rules descriptions may be edited to implement 504. For example, a rule may be modified to address at least one of the following: (a) where an opportunity moves from one stage to another (e.g., to negotiations or executive approval stages); (b) where the account meets a certain requirements (e.g., revenue from account exceeds a threshold amount); and/or (c) where contacts attached to an opportunity meets certain criteria (e.g., contact has a certain level of responsibility or position in his/her organization).

At 506, activities are selected for processing. This action uses selected activities to build links between opportunities and programs. A selection is made of the activities that will determine the link being created, including activities of a certain type (email opens, registrations etc.), activities prior to a certain date, activities from specific programs or microsites, activities with specific offers, and/or activities for specific contacts.

The conditions used to filter for the activities may include one or more of the following: (a) activity type corresponds to a certain type; (b) activity occurs within a certain time period relative to the opportunity; (c) condition pertains to the contact tied to opportunity in the CRM system with specific roles; (d) condition is tied to the primary contact associated with the opportunity in the CRM system; (e) condition pertains to the contacts tied to opportunity account; (f) condition pertains to a specific contact tied to opportunity account.

The rules descriptions may also be edited to implement this step of the process. For example the rules may be modified to address at least one of: (a) where an opportunity is created and/or moves from one stage to another; (b) where an opportunity meets a specified condition; (c) where activity is of a specific type; (d) activity occurs within a certain time period relative to the opportunity; and/or (e) where contacts attached to an opportunity meets certain criteria (e.g., contact has a certain role or meets a specified condition).

At 508, the association links are constructed to generate the links. This action activates the association rules and sets the schedule, where details are filled in for the rules and the rules are activated. The rules may be activated either for ongoing events, or by using a time window to review historical opportunities to analyze.

FIG. 6 logically illustrates the kind of associations that can be made between the marketing data and the sales data, where a given opportunity can be associated to different marketing activities based on association rule definitions. As shown in this figure, opportunities are connected to one or more programs, where the program activities are used to help establish the opportunity association. The associations pertain to the requirements of the rules that have been established for certain purposes. For example, the “sourcing” rules correspond to a first set of associations between programs and opportunities, the “tipping point” rules correspond to a second set of associations between programs and opportunities, and the “influence” rules correspond to a third set of associations between programs and opportunities.

In this example, it can be seen that sourcing rules provide for a one-to-one relationship between the opportunities and programs, whereas the tipping point and influence rule allow for a one-to-many relationship between the opportunities and programs. As described in more detail below, this aspect of these model arrangements affects the way in which the models perform revenue attribution.

After the opportunity association links have been generated, attribution analysis is then performed using the opportunity association links. FIG. 7 shows a flowchart of an approach to perform attribution analysis according to some embodiments of the invention.

At 702, model section is performed. As previously stated, there are a number of different attribution models that can be used to perform the attribution analysis. One example type of model is the sourcing model 703a, which identifies a unique program that is the “source” for a positive impact on the pipeline. Another example type of model is the tipping point model 703b, which identifies a set of programs that help pipeline move from one stage to another. A third example type of model is the influence model 703c, which quantifies the impact of various tactics on the overall pipeline. FIG. 8 illustrates an example interface that can be used to perform selection of an attribution model.

At 704, the selected model(s) are configured. One type of configuration that may be performed is to select and modify association rules for the selected model. Another type of configuration that may be performed is to configure program priorities. Revenue allocation rules may also be configured.

Thereafter, at 706, attribution processing is performed. This action attributes revenue to marketing programs that match the configured rules conditions. The analysis results may be provided to a user on a display device or stored into a computer readable medium.

Example processing actions for each of these models will now be discussed. The first model to be discussed at this point is the sourcing model. In some embodiments, the sourcing model attempts to identify a unique program that has a positive impact on the pipeline. This is different from the other described models, where there may be multiple programs that are attribution associated with an opportunity. Also, the source for this type of model typically does not change once it has been identified for a certain stage in the pipeline.

To illustratively explain this aspect of the invention, consider an example business use case where the company has the following background: (a) Customer A is a high-tech manufacturer of routing products and sells one product—Product X; (b) Customer generates 25 million in annual revenue; (c) Average deal size is 1 million dollars and average sales cycle is 6 months; (d) The company has a presence in North America and western Europe.

For this illustrative example, consider the project situation where the Customer has run with a contract manufacturer for 3 months and would like to build a sourcing model for Marketing ROI. The following requirements maybe applicable: (a) Include all activities recorded within 120 days prior to opportunity creation; (b) Pick the first program from the eligible list for each Opportunity; and (c) The candidate list of Programs and Activities for this analysis are (i) All clicks and registrations from all web campaigns (such as a Google campaign); (ii) All whitepaper registrations/downloads from corporate website; (iii) All attendance to events; and (iv) All anonymous/named web visits to Microsite X and Y.

After selection of the model, the association rules applied by the system can be reviewed and modified if necessary. FIG. 9 shows an example approach to select association rules to be used within a model. With this type of interface, the opportunity association rules are checked, where hyperlinks can be clicked to adjust the existing rules. Each hyperlink will enable edits, e.g., by launching a pop-up window. If necessary, new rules can be added from the library.

FIG. 10 shows an example approach to add an additional association rule from a library. This interface can be used to launch the library of association rules. It allows selection of any additional rules that might be required. A list of links is displayable in the interface, where clicking on the appropriate interface element (e.g., ‘Add selected links’ button) adds to the model.

The user can then perform program finalization, e.g., by reviewing and modifying the association rules applied by the system. FIG. 11 shows an example approach to perform finalization. This approach provides an interface to refresh the model and review the results. The details of the model can also be reviewed. In addition, the interface permits changes to be saved to the model.

Another type of attribution model is the tipping point model, where the tipping point model identifies a set of one or more programs that help pipeline move from one stage to another.

This analysis helps companies identify trends that can match campaign tactics with pipeline stages. For example this type of model can be used to identify: “What is the most effective program type for generating MQLs? Should investment be more in PPC or sponsor more external webinars?” As another example, this model can address: “What is the most effective program type that can help sales accelerate early appointments into forecasted opportunities? Should one invest more in events of a certain format or more invest more in 30 day trials?”

A company can have one or more tipping point models active at any given time. Each tipping point model tries to identify top X programs that ‘tip’ a lead or an opportunity from one stage to another.

To illustratively explain this embodiment, consider a business user case where the company has the following background: (a) Customer A is a high-tech manufacturer of routing products and sells one product—Product X; (b) Customer generates 25 million in annual revenue; (c) Average deal size is 1 million dollars and average sales cycle is 6 months; and (d) The company has a presence in North America and western Europe. The project situation is that the Customer would like to understand the top 3 programs that helped inside sales book an appointment for a field sales rep. The following requirements may apply: (a) Include all activities recorded between the stages sales lead creation and opportunity creation; (b) Pick the 3 most recent programs from the eligible list for each Opportunity; (c) Use allocation rules to spread the opportunity $$ to each program; and (d) The candidate list of Programs and Activities for this analysis are: (i) All whitepaper registrations/downloads from corporate website; (ii) All attendance to local events; (iii) All call blitz campaigns initiated by marketing.

After selection of the appropriate model, candidate selection made occur, where the association rules applied by the system are reviewed and modified if necessary. FIG. 12 shows an example approach to configure the association rule. With this type of interface, the opportunity association rules are checked, where hyperlinks can be clicked to adjust the existing rules. Each hyperlink will enable edits, e.g., by launching a pop-up window. If necessary, new rules can be added from the library.

Since there may be multiple marketing programs associated with a given opportunity, program priorities are configured for this model. From a list of selected programs, the interface is configured such that the user can select the appropriate ones for each opportunity, e.g., based at least in part on one or more the following: (a) Recency of the activity for one or more programs; (b) Programs with most number of respondents with a minimum threshold; and/or (c) Custom priority based on additional rules. FIG. 13 illustrates an example interface that can be employed to select program priorities.

Revenue allocation is then performed for the list of identified programs. The revenue allocation can be based upon a set of one or more allocation rules. In one approach, the revenue is evenly split among the programs. In another approach, the revenue split is performed with weighting, e.g., assigned by program fields. For example, a weight can be assigned to all programs linked to opportunities using an opportunity rule. Custom weights can be specified by defining rules to classify programs. In addition, a global set of weights assigned by program classifications can be re-used. Opportunity revenues can also be split using a business value assigned to links, using link rule conditions. Custom business values can also be configured to split the revenue. FIG. 14 illustrates an example interface that can be employed to configure revenue attribution parameters.

The influence model can also be used, where the influence model attempts to quantify the impact of various tactics on the overall pipeline. Typically, the influence analysis covers a broader set of stages in the pipeline. For example, consider if there is a need to measure the proportional impact that webinars have on an overall pipeline. Among the 5 active tactics employed, this approach can be used to state that webinars should get 25% credit (typically based on the proportional budget allocation). As another example, consider if there is a need to measure the proportional impact that telemarketing blitzes have on an overall pipeline. If one spends 40% of the budget on telemarketing, 40% credit can be applied to the overall impact to telemarketing.

A company can have one or more influencing models active at any given time. One possible motivation is for testing, e.g., where there is a need to compare results from a 120 day model based on program recency with a 120 day model based on ‘popularity’ based model.

After selection of the influence model, candidate selection made occur, where the association rules applied by the system are reviewed and modified if necessary. FIG. 15 shows an example approach to configure the association rule. With this type of interface, the opportunity association rules are checked, where hyperlinks can be clicked to adjust the existing rules. Each hyperlink will enable edits, e.g., by launching a pop-up window. If necessary, new rules can be added from the library.

Since there may be multiple marketing programs associated with a given opportunity for the influence model, program priorities are configured for this model. From a list of selected programs, the interface is configured such that the user can select the appropriate ones for each opportunity, e.g., based at least in part on one or more the following: (a) Recency of the activity for one or more programs; (b) Programs with most number of respondents with a minimum threshold; and/or (c) Custom priority based on additional rules. FIG. 16 illustrates an example interface that can be employed to select program priorities.

Revenue allocation is then performed for the list of identified programs. The revenue allocation can be based upon a set of one or more allocation rules. In one approach, the revenue is evenly split among the programs. In another approach, the revenue split is performed with weighting, e.g., assigned by program fields. For example, a weight can be assigned to all programs linked to opportunities using an opportunity rule. Custom weights can be specified by defining rules to classify programs. In addition, a global set of weights assigned by program classifications can be re-used. Opportunity revenues can also be split using a business value assigned to links, using link rule conditions. Custom business values can also be configured to split the revenue. FIG. 17 illustrates an example interface that can be employed to configure revenue attribution parameters. For basic revenue allocation, weights can be assigned to Activities by most commonly used Programs. Marketers may also add additional activity-program type combinations and assign weights to these categories. FIG. 18 illustrates an example interface that can be employed to add additional activity-program type combinations and assign weights to these categories.

FIG. 19 is a diagram of an illustrative system 1900 that can be used in some embodiments of the invention. A marketing interface 1906 is employed to allow a marketing user to access the system 1900. For example, data about marketing campaigns can be entered into a database 1908 and/or accessed using the marketing interface 1906. A sales user accesses the system 1900 through a sales interface 1912. For example, data about opportunities are entered into a database 1908 and/or accessed using the sales interface 1912.

Lead generation is performed at 1904. Leads are provided into the database 1908 from the lead generation process 1904. Responses are provided from the database 1904 to the lead generation process 1904.

Contacts interact with the system 1900 through a response capture engine 1902, which provide responses to database 1908. Outbound interactions are performed through an outbound interaction engine 1910. These engines permit the enterprise to communicate to contacts for marketing/sales activities.

The association builder 1914 generates opportunity association links. A rules engine applies a set of opportunity association rules to generate the associations. The revenue attribution engine 1916 performs analysis on the data within the database to generate the revenue attribution analysis results.

FIG. 20 illustrates logical interactions between the data in the system to generate the opportunity association links and the revenue attribution analysis results. The opportunity association model 2040 corresponds to the data maintained for the opportunity association links. The following are example data fields in the opportunity association model 2040: opportunity ID, campaign ID, activity ID, offer ID, stage 1D, contact ID, and/or lead ID. The revenue attribution model 2026 corresponds to the data maintained for the revenue attribution analysis results. The following are example data fields in the revenue attribution model 2040: model ID, opportunity ID, campaign ID, and/or revenue amount.

The organization data 2002 corresponds to account information for the enterprise. Opportunity data 2004 corresponds to information about identified opportunities for the enterprise. These items of data are typically maintained by the sales department(s) of the enterprise.

Campaign data 2010 corresponds to information about marketing campaigns for the enterprise. The stage information 2012 corresponds to the different stages of an opportunity. Marketing activity data 2016 pertain to the activities performed as part of a marketing campaign. This set of data corresponds to the interactions and responses from the company's contacts. The offer data 2014 corresponds to offers made by the enterprise to contacts.

The contact data 2008 corresponds to information about contacts for the company. Certain contacts may arise separately from the marketing contacts, and these are identified as the opportunity contacts 2006. Leads data 2018 corresponds to leads for the enterprise.

The Model type 202 comprises the data corresponding to models in the system. For example, data 202 corresponds to a list of pre-defined models, such as the sourcing model, tipping point model, and/or influence model. In some embodiments, the model types can be a snapshot model, which is typically used to analyze booked revenue. Another possible type of model is the point-in-time model, which is typically used to measure active pipeline in an active time window.

The attribution rules 2024 correspond to one or more rules that can filter and arbitrate one more programs and contacts that should be credited for an opportunity. For example, fractional revenue allocation rules can be defined which has one or more rules that allocate the forecasted amount or converted amount to the marketing programs.

The association rules 2024 correspond to one or more rules that relate opportunities to programs within the system. Various parameters pertaining to opportunity association rules can be configured. For example, the maximum number of programs per model can be set for an upper limit on number of programs that can be credited for one opportunity within a model.

There are various attribution types that can be maintained in the system. One type is the direct attribution type, which corresponds to data that already has associations. Another is the inferred type, which are inferences drawn where direct links do not exist. The manual type allows marketers to create/override rules based association.

Therefore, what has been described is an improved approach for performing opportunity association and attribution analysis. The invention provides an advanced rules framework to automatically infer associations between a set of marketing data and a set of sales data, allowing advanced revenue funnel analytics to be performed to measure marketing campaigns.

The present invention provides numerous advantages over prior approaches. For example, the invention can perform analysis without requiring enterprises to make specific entries into the CRM system that explicitly relate an opportunity to a sale or sales lead. This therefore avoids the possible analysis failures due to proper diligence, comprehensiveness, or accuracy for the entered data. Moreover, the present invention provides an advanced rules-based approach that permits a high level of customization to allow for great flexibility and applicability to different types of enterprises.

### System Architecture Overview

FIG. 21 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer implemented method implemented with a processor for performing marketing analysis, comprising:
identifying a set of marketing data and a set of sales data within an enterprise application;
generating association links between the set of marketing data and the set of sales data; and
performing model-based attribution analysis using the association links.

2. The method of claim 1, wherein the enterprise application comprises a CRM application.

3. The method of claim 1, in which the association links are generated by a rules engine using a set of association rules that implement matching conditions.

4. The method of claim 3, in which the set of association rules are configurable to correspond to an attribution model.

5. The method of claim 1, in which the association links are generated by a process comprising:
identifying a triggering event;
determining opportunities to process;
selecting activities to process; and
building associations.

6. The method of claim 1, in which the model-based attribution analysis is performed by a process comprising:
performing model selection;
configuring parameters for a model; and
performing attribution analysis.

7. The method of claim 1, in which the model-based attribution analysis corresponds to at least one of a sourcing model, tipping point model, and influence model.

8. The method of claim 1, in which the model-based attribution analysis performs revenue allocation.

9. The method of claim 8, in which weighting is performed to allocate revenue among multiple programs.

10. The method of claim 1, in which the model-based attribution analysis performs program prioritization.

11. A computer readable medium having stored thereon a sequence of instructions which, when executed by a processor causes the processor to execute a method for performing marketing analysis, the method comprising:
identifying a set of marketing data and a set of sales data within an enterprise application;
generating association links between the set of marketing data and the set of sales data; and
performing model-based attribution analysis using the association links.

12. The computer readable medium of claim 11, wherein the enterprise application comprises a CRM application.

13. The computer readable medium of claim 11, in which the association links are generated by a rules engine using a set of association rules that implement matching conditions.

14. The computer readable medium of claim 13, in which the set of association rules are configurable to correspond to an attribution model.

15. The computer readable medium of claim 11, in which the association links are generated by a process comprising:
identifying a triggering event;
determining opportunities to process;
selecting activities to process; and
building associations.

16. The computer readable medium of claim 11, in which the model-based attribution analysis is performed by a process comprising:
performing model selection;
configuring parameters for a model; and
performing attribution analysis.

17. The computer readable medium of claim 11, in which the model-based attribution analysis corresponds to at least one of a sourcing model, tipping point model, and influence model.

18. The computer readable medium of claim 11, in which the model-based attribution analysis performs revenue allocation.

19. The computer readable medium of claim 18, in which weighting is performed to allocate revenue among multiple programs.

20. The computer readable medium of claim 11, in which the model-based attribution analysis performs program prioritization.

21. A system for performing marketing analysis, comprising:
a processor;
a memory comprising computer code executed using the processor, in which the computer code implements identifying a set of marketing data and a set of sales data within an enterprise application, generating association links between the set of marketing data and the set of sales data, and performing model-based attribution analysis using the association links.

22. The system of claim 21, wherein the enterprise application comprises a CRM application.

23. The system of claim 21, in which the association links are generated by a rules engine using a set of association rules that implement matching conditions.

24. The system of claim 23, in which the set of association rules are configurable to correspond to an attribution model.

25. The system of claim 21, in which the computer code implements generating the association links by identifying a triggering event, determining opportunities to process, selecting activities to process, and building associations.

26. The system of claim 21, in which the computer code implements model-based attribution analysis by performing model selection, configuring parameters for a model, and performing attribution analysis.

27. The system of claim 21, in which the model-based attribution analysis corresponds to at least one of a sourcing model, tipping point model, and influence model.

28. The system of claim 21, in which the model-based attribution analysis performs revenue allocation.

29. The system of claim 28, in which weighting is performed to allocate revenue among multiple programs.

30. The system of claim 21, in which the model-based attribution analysis performs program prioritization.
